(19) United States
(12) Patent Application Publication
(10) Pub. No.: US 2002/0056085 A1
(43) Pub. Date: May 9, 2002

(54) Method and system for transferring and displaying graphical objects

(76) Inventor: Christer Fahraeus, Lund (SE)

Correspondence Address: BIRCH STEWART KOLASCH & BIRCH, PO BOX 747, FALLS CHURCH, VA, 22040-0747, US

(21) Appl. No.: 09/812,892

(22) Filed: Mar. 21, 2001

Related U.S. Application Data
(60) Provisional application No. 60/208,165, filed on May 31, 2000.

(30) Foreign Application Priority Data
Mar. 21, 2000 (SE) 0000941-5

(51) Int. Cl. H04N 7/16

(52) U.S. Cl. 725/1

(57) ABSTRACT

Methods are disclosed for processing a primary information object that may contain a graphical representation of a handwritten message. Image areas of the primary information object may be identified, based on the display characteristics of a display on which the message is intended to be shown. The image areas may contain parts of a handwritten message if such a message is included in the primary information object. A secondary information object containing one of the image areas may be created and transmitted to a recipient device.

### CROSS-REFERENCE TO RELATED APPLICATIONS

This application claims priority benefits based on Swedish Patent Application No. 0000941-

5, filed Mar. 21, 2000, and U.S. Provisional Application No. 60/208165, filed May 31, 2000, the technical disclosure of both of which are hereby incorporated herein by reference.

### FIELD OF THE INVENTION

The invention relates generally to wireless and computer networks and, more specifically, to transferring and displaying graphical objects in such systems.

### BACKGROUND OF THE INVENTION

A service used to a large extent in the GSM mobile telephone system is short text messages, more often called SMS (Short Message Service). SMS allows subscribers of the system to send text messages with a length of up to 160 characters from one mobile station to another. An SMS message can also be sent from a personal computer via an SMS server to a mobile station or in the opposite direction in the form of an e-mail message. A receiving mobile station does not need to be switched on when the message is sent, for the message can be stored in the mobile telephone system until the mobile station is connected.

In spite of the limited format, SMS has become very popular. GSM is considered to be a second-generation mobile telephone system and is primarily set up for providing circuit-switched voice communication services. In a third-generation mobile system, more often known by acronyms such as WCDMA or CDMA-2000, packet data services with large bandwidths will instead be provided. Packet data services will also be provided by upgrades (such as GPRS and EDGE) to second-generation mobile telephone systems. An advantage of broadband packet data services is the possibility of transferring files that contain graphics.

If there is a possibility of transferring graphical information, the transfer of handwritten messages produced by digital means is also possible. The text messages could thus be made more individualized. Moreover, characters which are known by the sender and the receiver could be transmitted even if the mobile stations and the intermediate system(s) were not adapted for such characters. For example, Japanese characters could be sent by mobile stations adapted for the Latin alphabet.

One difficulty associated with the transfer of such a message is that the displays of the mobile stations are often relatively small. This usually makes it impossible to show a complete file, which may be in GIF format. A message that contains a digital graphical representation of a handwritten message of some length and recorded with some resolution will normally be many times larger than the display of the receiving mobile station. Also, a handwritten message will typically be written sparsely with respect to the surface area on which it is represented, compared with a message of the SMS type.

A conceivable possibility of showing the message is to reduce it in size until it can fit into the display of the mobile station. One problem with such a method is that the resolution in the display of most mobile stations is so low that most of the messages would be unreadable, especially if the sender has a dense handwriting.

Another conceivable method of showing the message is to show only a small part of the image file and allow the receiver to use the keys of the mobile station to move up, down, to the left, and to the right across the image. However, depending on the details, this could be difficult and cumbersome. In addition, there may be no guarantee that the message is oriented horizontally in the image. It may well be written diagonally in the image file, complicating display of the message. If the receiver scrolls across the image, there may also be a risk that some of the message will be bypassed if it is positioned, for example, down in one corner.

### SUMMARY OF A FEW ASPECTS OF THE INVENTION

The invention may include a method for transmitting over a network a graphical object that may be in the form of a digital file. The method may be embodied in a computer program that may be stored in any of numerous computer-readable media known to those skilled in the art. A wireless network switching node, a personal computer, a mobile device, and other such units may be adapted to perform the method by including the program in them.

The program may identify display characteristics of a recipient device, which may be a mobile station wirelessly connected to the network. Then, the program may identify image areas of the graphical object apportioned to match the display characteristics of the recipient device. After creating at least one secondary graphical object that includes one of the image areas, the program may transmit the secondary graphical object over the network to the recipient device.

The invention may also include a program for displaying a graphical object. The program may be included in a mobile station wirelessly connected to a network. The mobile station may receive the graphical object from over the network. The program may then identify image areas of the graphical object apportioned to match display characteristics of the mobile station. After doing so, the program may then show one of the image areas on a display of the mobile station.

The foregoing summarizes only a few aspects of the invention and is not intended to be reflective of the full scope of the invention, as claimed. In addition, both the foregoing general description and the following detailed description are exemplary and explanatory only and are not restrictive of the invention as claimed.

### BRIEF DESCRIPTION OF THE DRAWINGS

FIG. 1 shows in a simplified manner a mobile telephone system in which embodiments of the invention can be used.

FIG. 2 shows schematically a general method according to one embodiment of the invention.

FIGS. 3a, 3b, and 3c are flow charts illustrating steps in a method in a mobile telephone system according to an embodiment of the invention.

FIG. 4 is a flow chart illustrating a method for displaying a primary information object in a mobile station which receives it, in accordance with an embodiment of the invention.

FIG. 5 is a flow chart illustrating a method in a first mobile station which intends to send information to a second mobile station, in accordance with an embodiment of the invention.

FIG. 6 is a flow chart illustrating a method for processing a primary information object, in accordance with an embodiment of the invention.

### DETAILED DESCRIPTION OF PREFERRED EMBODIMENTS

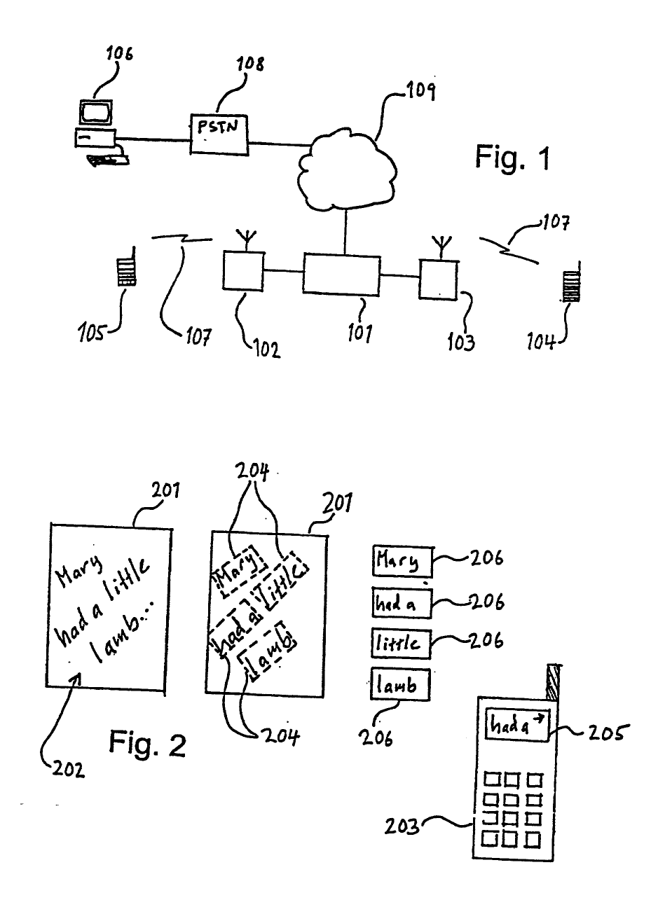

FIG. 1 shows in a simplified manner an exemplary mobile telephone system 101, 102, 103 in which the invention can be utilized. This system may be a GSM system with GPRS functionality. A primary information object (also called a graphical object) that may be a digital file representing a handwritten message is sent to a receiving mobile station 104. The sender can be using a sending mobile station 105 or other electronic equipment such as a personal computer 106.

In the case where a mobile station 105 is sending the information object, it may be sent via the air interface 107 to a first base station 102. From there, it may be sent via one or more switching nodes 101, a second base station 103, and the air interface 107 to the receiving mobile station 104.

If the sender is an Internet-connected personal computer 106 or server, the message may be sent via the public telephone network PSTN 108 and Internet 109 to a gateway node in the mobile telephone system. After that, it may be sent on to the receiving mobile station 104.

The transmission of the information object may be done by packet data transmission in which an information object is divided into a plurality of parts that are transmitted one by one. The transmission of a packet can entail traffic in both directions in accordance with the TCP/IP protocol.

A method according to the invention can be carried out at various locations in the system shown above. Thus, a method according to the invention can be carried out in the transmitting mobile station 105, in the receiving mobile station 104, in the transmitting Internet-connected electronic equipment 106 or in a node (such as a switching node) connected to the mobile telephone system (for example 101).

FIG. 2 shows schematically a general method according to one example of the invention. A primary information object 201 is shown. The primary information object 201 contains a handwritten message 202. The primary information object 201 may be represented by a digital file. The file may be a compressed file such as a GIF or JPEG file or a file of non-compressed format such as a BMP or TIFF file. The handwritten message 202 indicates that a number of pixels in the file, corresponding to memory elements, have changed state.

The graphical representation of the handwritten message may be produced with the aid of an optical sensor which is displaced over a base on which a position-coding pattern is printed. The optical sensor may then be adapted to detect absolute positions on the base by utilizing the position-coding pattern. A displacement of the optical sensor over such a base may be recorded as a sequence of positions which correspond to the displacement. Such an optical sensor may be accommodated in a drawing device which forwards position data to a computer system in, for example, a mobile station or a personal computer. The drawing device can be provided with a drawing pen with the result that said displacement is also recorded on the base in the form of an ink trace. Such an arrangement with base and drawing device provides for inputting on a large area. Nevertheless, the drawing device can be made compact and the base may be a foldable sheet of paper.

One embodiment of the drawing device is a mobile, pen-shaped unit that includes the optical sensor, the computer system, a memory, and a communication device such as a short-range radio link or an IR-link (infrared link). The handwritten data may be obtained in a vector format, which has relatively small size.

One position-coding pattern is disclosed in WO 00/73983, and another is disclosed in PCT/SE00/01895. The technical disclosure of each of these applications are hereby incorporated into the present specification by reference. A notebook in which a message, such as described above, may be generated is disclosed in WO/01/16691, the technical disclosure of which is hereby incorporated into the present specification by reference.

When a system has knowledge of display characteristics of a mobile station 203 in which the message is intended to be shown, the system can divide the message in a manner suitable for the receiving mobile station 203. This may be done by identifying image areas 204 having a size that is adapted to the display 205 of the receiving mobile station 203 and that contain parts of the handwritten message of the primary information object. Segmenting algorithms that carry out segmentation at word level in a known manner may also aid identification of image areas 204. These algorithms identify image areas that contain one word or in certain cases a number of words. The display characteristics can be advantageously made up of the number of pixels in the display along first and second right-angle directions of extension.

When relevant image areas 204 have been identified, secondary information objects 206 (also called secondary graphical objects) may be created. These secondary information objects 206 may be represented by digital files. The content therein may be allotted the content in one or more of the identified image areas 204.

For the sender to receive display characteristics of an intended recipient's mobile station 203 (or other display device), the sender may send one or more request signals to the recipient's mobile station. In reply, the mobile station may return one or more signals reflective of its associated display characteristics. Thereafter, appropriate information objects 206 may be created. Alternatively, the information objects 206 may be created after a request is sent and a reply received from an intermediary, such as a network node, that identifies the display characteristics. This functionality may be enabled by hardware or software that is part of the network and/or part of one or more of the sender's and recipient's transmission devices.

The result of creating information objects 206 by such methods is to divide the primary information object 202 into portions that are just the right size for display on the mobile station 203. This allows any message contained in the primary information object 202 to be shown with good resolution and with only a small number of, or perhaps no, button depressions. In other words, through such methods, the format of graphical objects can be customized to match the display characteristics of an intended recipient's display device. A diagonally written message can also be shown with an orientation that is correct for the mobile station by reorienting words contained in the image areas 204 in the information objects 206.

The secondary information objects 206 can also be included as elements in a common file. The secondary information objects can then be shown on the display 205 of the mobile station 203.

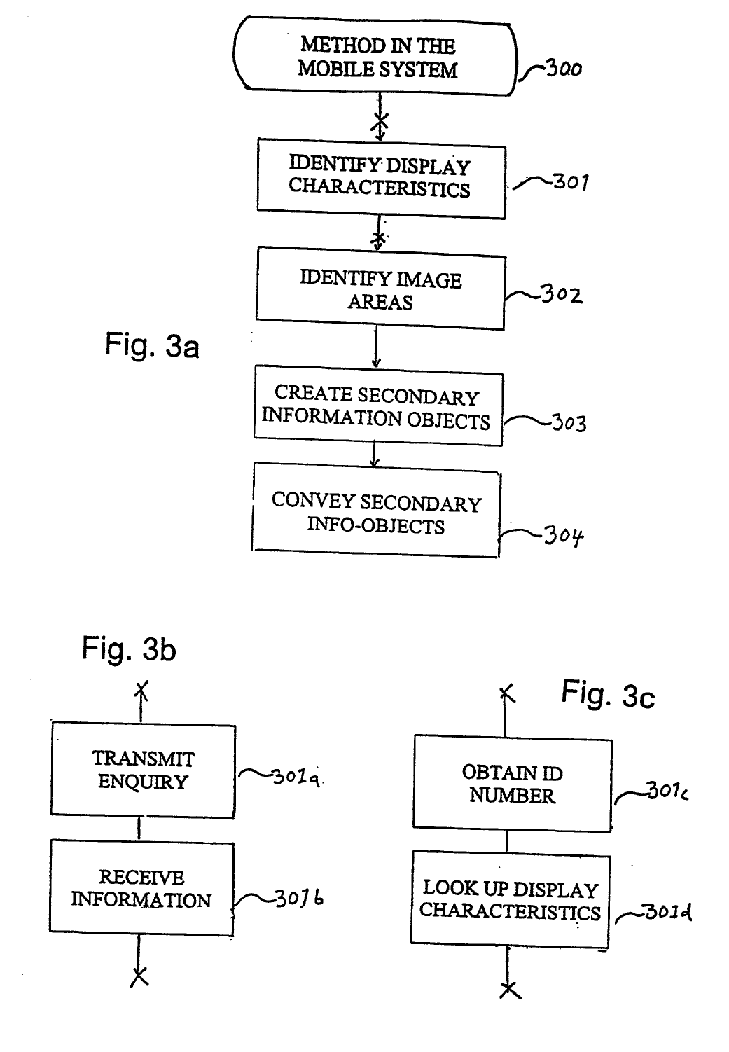

FIG. 3a shows steps in an exemplary method 300 in a mobile telephone system, where a node in the system is adapted to forward information to a mobile station that is connected to the system.

A primary information object, perhaps containing a graphical representation of a handwritten message, arrives at said node. In step 301, display characteristics of the receiving mobile station are identified. In step 302, image areas that contain parts of the handwritten message are identified in the primary information object.

In step 303, secondary information objects that may be files are created. These information objects are then conveyed to the receiving mobile station in step 304.

FIG. 3b shows an exemplary first embodiment of step 301 shown in FIG. 3a. In a first substep 301a, an inquiry is sent to the receiving mobile station for characteristics of its display. In a second step 301b, such information about display characteristics is received.

FIG. 3c shows an exemplary second embodiment of step 301 shown in FIG. 3a. In a first substep 301c, a hardware-identifying number relating to the receiving mobile station is obtained. This number can be made up of, for example, the so-called IMEI code (in a GSM system), which is known to the system. In a second step 301d, a lookup table is used which, using this number as input data, provides output data corresponding to the desired information relating to display characteristics. This enables the method to be carried out without previous communication with the mobile station.

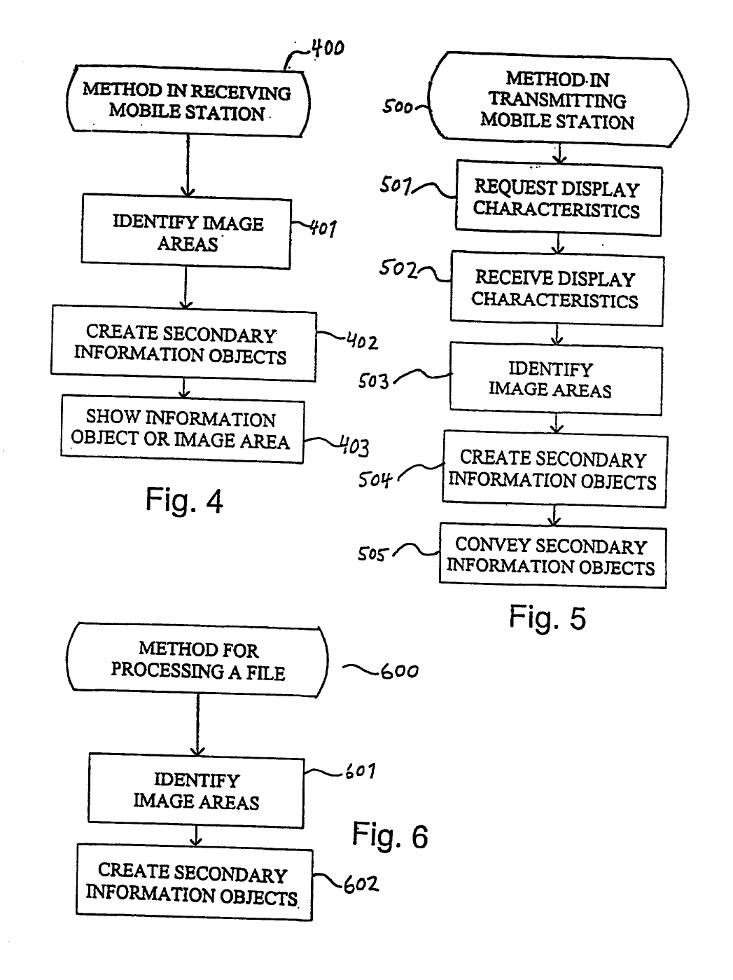

FIG. 4 shows an exemplary method 400 for displaying a primary information object, perhaps containing a graphical representation of a handwritten message, in a mobile station of a mobile telephone system.

In step 401, image areas are identified in the primary information object. After that, a number of secondary information objects, which may be allotted the content in the identified image areas, are created in step 402. In step 403, these information objects are shown on the display of the mobile station. This display may be done sequentially for one image area at a time. It may not be necessary to explicitly create a secondary information object, as an identified image area can also be shown directly on the display of the mobile station.

FIG. 5 shows an exemplary method 500 in a first mobile station that intends to send a primary information object to a second mobile station with specific display characteristics. In step 501, the first mobile station requests the display characteristics of the second mobile station. This can be done directly to the second mobile station, to an intermediate node that has knowledge of these display characteristics, or to an intermediate node that requests the display characteristics. In step 502, the first mobile station receives the display characteristics requested. In step 503, image areas are identified in the primary information object. After that, secondary information objects containing the image areas are created in step 504. These are then forwarded to the second mobile station in step 505.

FIG. 6 shows a more general method 600 for processing a file corresponding to a primary information object. The method may correspond to instructions in the form of program steps stored in a computer-readable information medium. The program, in turn, may be carried out by such electronic equipment as a personal computer, a mobile device, or a switching node.

In step 601, image areas in a primary information object that contain parts of a handwritten message are identified, perhaps based on display characteristics of a recipient device that is to receive the message. After that, secondary information objects such as files containing the identified image areas are created in step 602. These may be sent to the recipient device. Typical recipient devices include mobile devices, personal computers, and Internet appliances.

The scope of protection is not limited by the embodiments described above. The invention can be varied and changed in a number of ways within the scope of the appended claims.

Concurrently filed with the application for this patent are applications entitled Systems and Methods for Information Storage based on Swedish Application No. 0000947-2, filed Mar. 21, 2000, and U.S. Provisional Application No. 60/207,839, filed May 30, 2000; Secured Access Using a Coordinate System based on Swedish Application No. 0000942-3, filed Mar. 21, 2000, and U.S. Provisional Application No. 60/207,850 filed on May 30, 2000; System and Method for Printing by Using a Position Coding Pattern based on Swedish Application No. 0001245-0, filed on Apr. 5, 2000, and U.S. Provisional Application No. 60/210,651, filed on Jun. 9, 2000; Apparatus and Methods Relating to Image Coding based on Swedish Application No. 0000950-6, filed on Mar. 21, 2000, and U.S. Provisional Application No. 60/207,838, filed on May 30, 2000; Apparatus and Methods for Determining Spatial Orientation based on Swedish Application No. 0000951-4, filed on Mar. 21, 2000, and U.S. Provisional Application No. 60/207,844, filed on May 30, 2000; System and Method for Determining Positional Information based on Swedish Application No. 0000949-8, filed Mar. 21, 2000, and U.S. Provisional Application No. 60/207,885, filed on May 30, 2000; Method and System for Transferring and Displaying Graphical Objects based on Swedish Application No. 0000941-5, filed Mar. 21, 2000, and U.S. Provisional Application No. 60/208,165, filed May 31, 2000; Online Graphical Message Service based on Swedish Application No. 0000944-9, filed Mar. 21, 2000, and U.S. Provisional Application No. 60/207,881, filed May 30, 2000; Method and System for Digitizing Freehand Graphics With User-Selected Properties based on Swedish Application No. 0000945-6, filed Mar. 21, 2000, U.S. Provisional Application No. 60/207,882, filed May 30, 2000; Data Form Having a Position-Coding Pattern Detectable by an Optical Sensor based on Swedish Application No. 0001236-9, filed Apr. 5, 2000, and U.S. Provisional Application No. 60/208,167, filed May 31, 2000; Method and Apparatus for Managing Valuable Documents based on Swedish Application No. 0001252-6, filed Apr. 5, 2000, and U.S. Provisional Application No. 60/210,653 filed Jun. 9, 2000; Method and Apparatus for Information Management based on Swedish Application No. 0001253-4 filed Apr. 5, 2000, and U.S. Provisional Application No. 60/210,652, filed Jun. 9, 2000; Device and Method for Communication based on Swedish Application No. 0000940-7, filed Mar. 21, 2000, and U.S. Provisional Application No. 60/208,166, filed May 31, 2000; Information-Related Devices and Methods based on Swedish Application No. 0001235-1, filed Apr. 5, 2000, and U.S. Provisional Application No. 60/210,647, filed Jun. 9, 2000; Processing of Documents based on Swedish Application No. 0000954-8, filed Mar. 21, 2000, and U.S. Provisional Application No. 60/207,849, filed May 30, 2000; Secure Signature Checking System based on Swedish Application No. 00009431, filed Mar. 21, 2000, and U.S. Provisional Application No. 60/207,880, filed May 30, 2000; Identification of Virtual Raster Pattern, based on Swedish Application No. 0001235-1, filed Apr. 5, 2000, and U.S. Provisional Application No. 60/210,647, filed Jun. 9, 2000, and Swedish Application No. 0004132-7, filed Nov. 10, 2000, and U.S. Provisional Application No. ______, filed Jan. 12, 2001; and a new U.S. Provisional Application entitled Communications Services Methods and Systems.

The technical disclosures of each of the above-listed U.S. applications, U.S. provisional applications, and Swedish applications are hereby incorporated herein by reference. As used herein, the incorporation of a “technical disclosure” excludes incorporation of information characterizing the related art, or characterizing advantages or objects of this invention over the related art.

In the foregoing Description of Preferred Embodiments, various features of the invention are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Preferred Embodiments, with each claim standing on its own as a separate preferred embodiment of the invention.

What is claimed is:

1. A method for transmitting a graphical object over a network, the method comprising:
identifying at least one display characteristic of a recipient device;
identifying image areas of the graphical object apportioned to match the at least one display characteristic;
creating at least one secondary graphical object including one of the image areas; and
transmitting the at least one secondary graphical object over the network to the recipient device.

2. The method of claim 1, wherein the graphical object comprises a handwritten message.

3. The method of claim 1, wherein the at least one display characteristic comprises a size of a display of the recipient device.

4. The method of claim 1, wherein the at least one display characteristic comprises a shape of a display of the recipient device.

5. The method of claim 1, wherein the at least one display characteristic comprise a resolution of a display of the recipient device.

6. The method of claim 1, wherein the recipient device comprises a mobile station wirelessly connected to the network.

7. The method of claim 1, wherein the network comprises a wireless network.

8. The method of claim 1, wherein the network comprises a mobile telephone system.

9. The method of claim 1, wherein the network comprises a computer network.

10. The method of claim 1, further comprising transmitting multiple secondary graphical objects over the network to the recipient device, one at a time.

11. The method of claim 1, wherein transmitting the at least one secondary graphical object over the network to the recipient device comprises transmitting together multiple secondary graphical objects over the network to the recipient device.

12. The method of claim 1, wherein transmitting the at least one secondary graphical object over the network to the recipient device comprises transmission from a mobile station wirelessly connected to the network.

13. The method of claim 1, wherein the recipient device comprises a mobile station wirelessly connected to the network, and wherein the at least one secondary graphical object is created at a switching node of the network.

14. The method of claim 1, wherein identifying the at least one display characteristic of the recipient device comprises:
transmitting a display characteristic inquiry over the network to the recipient device; and
receiving a response from the recipient device that includes the at least one display characteristic.

15. The method of claim 1, wherein identifying the at least one display characteristic of the recipient device comprises:
obtaining a hardware-identifying identity number relating to the recipient device; and
obtaining the at least one display characteristic from a lookup table using the identity number.

16. The method of claim 1, wherein the graphical object comprises a handwritten message, and identifying the image areas of the graphical object comprises:
identifying a word in the handwritten message; and
selecting one of the image areas to include the word.

17. The method of claim 16, wherein creating the at least one secondary graphical object comprises:
including the image area corresponding to the word in the secondary graphical object; and
reorienting the word in the secondary graphical object to improve readability.

18. A computer-readable medium having computer-executable instructions for performing the method of claim 1.

19. A wireless network switching node adapted to perform the method claim 1.

20. A mobile device adapted to perform the method of claim 1.

21. A computer adapted to perform the method of claim 1.

22. A method for displaying a graphical object, comprising:
receiving, at a mobile station wirelessly connected to a network, the graphical object from over the network;
identifying image areas of the graphical object apportioned to match display characteristics of the mobile station; and
showing at least one of the image areas on a display of the mobile station.

23. The method of claim 22, further comprising sequentially showing multiple image areas on the display of the mobile station.

24. The method of claim 22, wherein the display characteristics comprise a number of pixels along a first direction of orientation on the display and a number of pixels along a second direction of orientation on the display, the first direction and the second direction being substantially orthogonal.

25. The method of claim 22, wherein the graphical object comprises a handwritten message.

26. A computer-readable medium having computer-executable instructions for performing the method of claim 22.

27. A mobile station adapted to perform the method of claim 22.

28. A method of customizing a transmission of graphical material to a characteristic of an intended recipient's display device, the method comprising:
enabling the sending of, prior to transmission of the graphical material, at least one signal reflective of a request for identification of at least one display characteristic of the intended recipient's display device;
enabling a reply to said at least one signal reflective of the intended recipient's at least one display characteristic;
enabling the formatting of a format of the graphical material to be customized to the intended recipient's display characteristic;
enabling transmission to the intended recipient of the graphical material in a format customized for the intended recipient's display device; and
enabling display on the intended recipient's display device of the custom formatted graphical material.

29. The method of claim 28, wherein the intended recipient's display device is part of a wireless communications device.

30. The method of claim 28, wherein the intended recipient's display device is part of a mobile telephone.

31. The method of claim 28, wherein the graphical material includes an electronic facsimile of a sender's handwriting.

32. A method of customizing a transmission of graphical material to a characteristic of an intended recipient's display device, the method comprising:
enabling the sending of, prior to transmission of the graphical material, at least one signal reflective of a request for identification of at least one display characteristic of the intended recipient's display device;
enabling a reply to said at least one signal reflective of the intended recipient's at least one display characteristic;
enabling the dividing of the graphical material into subparts, each subpart being customized to the intended recipient's display characteristic;
enabling the transmission of the subparts to the intended recipient; and
enabling the display of the subparts on the intended recipient's display device.

33. The method of claim 32, wherein the intended recipient's display device is part of a wireless communications device,

34. The method of claim 32, wherein the intended recipient's display device is part of a mobile telephone.

35. The method of claim 32, wherein the graphical material includes an electronic facsimile of a sender's handwriting.
